(19) United States
(12) Patent Application Publication
(10) Pub. No.: US 2024/0230942 A9
(43) Pub. Date: Jul. 11, 2024

(54) Method and System for Real-Time Calculating a Microseismic Focal Mechanism Based on Deep Learning

(71) Applicant: INSTITUTE OF GEOLOGY AND GEOPHYSICS, CHINESE ACADEMY OF SCIENCES, Beijing (CN)

(72) Inventors: Shaojiang WU, Beijing (CN); Yibo WANG, Beijing (CN); Yikang ZHENG, Beijing (CN); Yi YAO, Beijing (CN)

(21) Appl. No.: 18/199,531

(22) Filed: May 19, 2023

(30) Foreign Application Priority Data
Oct. 25, 2022 (CN) 202211306096.5

(51) Int. Cl. G01V 1/50; G01V 1/46; G06N 3/0464

(52) U.S. Cl. CPC G01V 1/50; G01V 1/46; G06N 3/0464

(57) ABSTRACT

A method and system for real-time calculating a microseismic focal mechanism based on deep learning is provided, which belongs to the technical field of microseismic monitoring. The method includes: creating a training dataset, the training data including simulated DAS microseismic strain data and a focal mechanism corresponding to the simulated DAS microseismic strain data; training a focal mechanism calculation model by using the training dataset, with the simulated DAS microseismic strain data as an input and the focal mechanism corresponding to the simulated DAS microseismic strain data as a target output, so as to obtain a trained focal mechanism calculation model; collecting DAS microseismic strain data by a surface and downhole DAS acquisition system; performing preprocess operations such as removing abnormally large values on the DAS microseismic strain data; inputting the preprocessed DAS microseismic strain data into a trained focal mechanism calculation model to obtain a focal mechanism.

### CROSS REFERENCE TO RELATED APPLICATION

This patent application claims the priority to Chinese Patent Application No. 202211306096.5, entitled “Method and System for Calculating a Real-Time Microseismic Focal Mechanism based on Deep Learning” filed with China National Intellectual Property Administration on Oct. 25, 2022, the disclosure of which is incorporated by reference herein in its entirety.

### TECHNICAL FIELD

The present disclosure relates to the technical field of microseismic monitoring, in particular to a method and system for real-time calculating a microseismic focal mechanism based on deep learning.

### BACKGROUND ART

Hydraulic fracturing techniques inject high-pressure fluid into shale reservoirs to produce complex artificial fractures, which can increase reservoir connectivity and well production. Monitoring and evaluating hydraulic fracturing stimulation of reservoir in different stages is a premise tool for efficient development and safe production. In a process of hydraulic fracturing, a high-pressure pump is arranged at a wellhead to inject fracturing fluid into the fractured well, and due to stress changes, reservoirs are fractured, resulting in microseismity.

Microseismic monitoring techniques monitor the fracturing process and evaluate the fracturing effect by analyzing the microseismic signals generated during the hydraulic fracturing process, and optimizing the engineering parameters. Microseismic monitoring techniques are an important tool to real-time monitor the hydraulic fracturing in development of unconventional resources. Microseismic monitoring techniques mainly include event picking, microseismic source locating, microseismic focal analysis (microseismic focal mechanism and microseismic magnitude), reservoir stress analysis, reservoir fracture calculation, stimulated reservoir volume and so on. The microseismic focal mechanism can reveal the generation mechanism of microseism and stress change of underground reservoirs, and further optimize the design of reservoir stimulation to improve recovery ratio.

In current microseismic monitoring of hydraulic fracturing, many researchers have analyzed and studied the microseismic focal mechanism inversion, for example, the focal mechanism inversion based on first motion polarity, amplitude and waveform-related information. However, the above focal mechanism inversion strategy based on first motion polarity, amplitude, and waveform-related information are usually applied to data collected by conventional acquisition systems, which generally is displacement, velocity, or acceleration data, but not strain data collected by DAS acquisition system. The strain data need to be converted to the displacement, velocity, or acceleration data, which results in a low efficiency and a low accuracy. Therefore, it is desirable for a new real-time microseismic focal mechanism calculation method that is suitable for strain data.

### SUMMARY

The objective of some embodiments of the present disclosure is to provide a method and system for real-time calculating microseismic focal mechanism based on deep learning, which improves efficiency and accuracy of focal mechanism calculation.

To achieve the above objective, the present disclosure provides the following solutions.

A method for real-time calculating a microseismic focal mechanism based on deep learning, including:
building a training dataset including a plurality of training data, the training data including simulated Distributed Acoustic Sensing (DAS) microseismic strain data and a focal mechanism corresponding to the simulated DAS microseismic strain data;
training a focal mechanism calculation model by using the training dataset, with the simulated DAS microseismic strain data as an input and the focal mechanism corresponding to the simulated DAS microseismic strain data as a target output, so as to obtain a trained focal mechanism calculation model;
collecting DAS microseismic strain data by a surface and downhole DAS acquisition system, the DAS microseismic strain data including longitudinal-wave (P-wave) information and/or shear-wave (S-wave) information recorded in multiple channels;
preprocessing the DAS microseismic strain data to obtain preprocessed DAS microseismic strain data, the preprocessing including removing abnormal large values from data recorded in each channel of the DAS microseismic strain data;
inputting the preprocessed DAS microseismic strain data into the trained focal mechanism calculation model to obtain a focal mechanism.

Alternatively, parameters of the focal mechanism include a rake angle, a strike angle and a dip angle; the building a training dataset including a plurality of training data includes:
determining a plurality of simulated focal mechanisms within value ranges of various parameters of the focal mechanism;
generating simulated DAS microseismic strain data corresponding to each simulated focal mechanism according to the simulated focal mechanism;
deeming each simulated DAS microseismic strain data and corresponding simulated focal mechanism as a training datum to obtain a training dataset.

Alternatively, the value ranges of various parameters of the focal mechanism are: 0°<rake angle<180°, 0°<strike angle<360°, 0°<dip angle<90°.

Alternatively, after the generating simulated DAS microseismic strain data corresponding to each simulated focal mechanism according to the simulated focal mechanism, before the deeming each simulated DAS microseismic strain data and corresponding simulated focal mechanism as a training datum to obtain a training dataset, the method further includes:
adding background noise to the simulated DAS microseismic strain data, the background noise being background noise during real monitoring.

Alternatively, after the building a training dataset including a plurality of training data, the method further includes:
randomly selecting a plurality of the simulated DAS microseismic strain data in the training dataset;
setting data of a plurality of random channels in the selected simulated DAS microseismic strain data to null, to obtain simulated DAS microseismic strain data with abnormal channels.

Alternatively, the focal mechanism calculation model is a neural network model, and the focal mechanism calculation model includes four convolution blocks and two fully-connected blocks, which are connected in sequence; the four convolution blocks each include a convolution layer, an activation layer, a maximum pooling layer and a Dropout layer connected in sequence.

Alternatively, the activation layer adopts a ReLU activation function.

Corresponding to the above method for real-time calculating a microseismic focal mechanism, the present disclosure also provides a system for real-time calculating a microseismic focal mechanism based on deep learning. The system includes:
a training dataset building module configured to build a training dataset including a plurality of training data, the training data including simulated DAS microseismic strain data and a focal mechanism corresponding to the simulated DAS microseismic strain data;
a calculation model training module configured to train a focal mechanism calculation model by using the training dataset, with the simulated DAS microseismic strain data as an input, and the focal mechanism corresponding to the simulated DAS microseismic strain data as a target output, so as to obtain a trained focal mechanism calculation model;
a data collection module configured to collect DAS microseismic strain data by a surface and downhole DAS acquisition system, the DAS microseismic strain data including P-wave and/or S-wave information recorded in a plurality of channels;
a data preprocessing module configured to preprocess the DAS microseismic strain data to obtain preprocessed DAS microseismic strain data, the preprocessing including removing abnormal large values from data recorded in each channel of the DAS microseismic strain data;
a focal mechanism calculation module configured to input the preprocessed DAS microseismic strain data into the trained focal mechanism calculation model to obtain a focal mechanism.

Alternatively, parameters of the focal mechanism include a rake angle, a strike angle and a dip angle; and the training dataset building module includes:
a focal mechanism simulation unit configured to determine a plurality of simulated focal mechanisms within value range of various parameters of the focal mechanism;
a DAS microseismic strain data generation unit configured to generate simulated DAS microseismic strain data corresponding to each simulated focal mechanisms according to the simulated focal mechanism, and to deem each simulated DAS microseismic strain data and corresponding simulated focal mechanism as a training datum to obtain a training dataset.

Alternatively, the training dataset building module further includes:
a background noise adding unit configured to add background noise to a plurality of the simulated DAS microseismic strain data, the background noise being background noise during real monitoring.

According to the specific embodiments provided by the present disclosure, the present disclosure discloses the following technical effects.

The present disclosure provides a method and system for real-time calculating a microseismic focal mechanism based on deep learning. The method includes: building a training dataset including a plurality of training data, the training data including simulated DAS microseismic strain data and a focal mechanism corresponding to the simulated DAS microseismic strain data; training a focal mechanism calculation model by using the training dataset, with the simulated DAS microseismic strain data as an input, and with the focal mechanism corresponding to the simulated DAS microseismic strain data as a target output, so as to obtain a trained focal mechanism calculation model; collecting DAS microseismic strain data by a surface and underground DAS acquisition system; the DAS microseismic strain data including P-wave information and/or S-wave information recorded in multiple channels; preprocessing the DAS microseismic strain data to obtain preprocessed DAS microseismic strain data, the preprocessing including removing abnormal large values from data recorded in each channel of the DAS microseismic strain data; inputting the preprocessed DAS microseismic strain data into the trained focal mechanism calculation model to obtain a focal mechanism.

The method and system for calculating a microseismic focal mechanism provided by the present disclosure trains the focal mechanism calculation model by using the training dataset, so that the focal mechanism calculation model can learn relationship between the DAS microseismic strain data and the focal mechanism, so as to accurately calculate the focal mechanism through the DAS microseismic strain data, and improve efficiency of focal mechanism calculation. Further, the DAS microseismic strain data in the present disclosure uses P-wave information and/or S-wave information. Compared with the existing focal mechanism inversion strategy, information used is no longer limited to a single type, and the focal mechanism finally calculated is more accurate. In addition, in the present disclosure, the corresponding DAS microseismic strain data is generated through focal mechanism simulation, so that the amount of data that can participate in the training of the focal mechanism calculation model is increased, and the problems like lacking of training data and the inadequate training of focal mechanism calculation model are avoided.

### BRIEF DESCRIPTION OF THE DRAWINGS

In order to clearly illustrate the technical solutions in the embodiments of the present disclosure or in the prior art, the drawings required in the embodiments will be briefly introduced below. Apparently, the drawings in the following description are only some embodiments of the present disclosure, for those of ordinary skill in the art, other drawings may also be obtained from these drawings without any creative effort.

FIG. 1 is a flowchart of a real-time microseismic focal mechanism calculation method based on deep learning according to embodiment 1 of the present disclosure;

FIG. 2 is a flowchart of step S1 in the method according to embodiment 1 of the present disclosure;

FIG. 3 is a schematic structural diagram of a focal mechanism calculation model in the method according to embodiment 1 of the present disclosure;

FIG. 4 is a layout diagram of a surface and downhole DAS acquisition system in the method according to embodiment 1 of the present disclosure;

FIG. 5 is a schematic structural diagram of a real-time microseismic focal mechanism calculation system based on deep learning according to embodiment 2 of the present disclosure.

### DETAILED DESCRIPTION OF THE EMBODIMENTS

In the following, the technical solutions in the embodiments of the present disclosure will be clearly and completely described with reference to the accompanying drawings in the embodiments of the present disclosure. Apparently, the described embodiments are only a part rather than all of the embodiments of the present disclosure. Based on the embodiments of the present disclosure, all other embodiments obtained by those of ordinary skill in the art without creative efforts belong to the protection scope of the present disclosure.

In the process of hydraulic fracturing microseismic monitoring, inversion and interpretation of microseismic focal mechanisms have also been analyzed and studied by many researchers, which include the following methods.

An inversion method based on first motion polarity constraints may utilize a polarity of a first arrival P wave recorded by various geophones to find two orthogonal planes that divide the polarities, so as to obtain a solution of the focal mechanism based on shear dislocation model.

An inversion method based on amplitude constraints utilizes information about absolute amplitude of P-wave (or S-wave) or amplitude ratio of S-wave and P-wave.

In addition to the above constraints based on the first motion polarity and amplitude, some study of microseismic focal mechanism uses waveform information as a constraint condition of the inversion, where the waveform (or full waveform) information refers to a partial or whole microseismic record of real records. This type of method does not extract a single feature of microseismic records (such as first motion polarity, amplitude of P wave, etc.), but directly uses the whole record to construct an objective function for inversion.

However, the above inversion methods of the microseismic focal mechanism based on single constraint such as first motion polarity, amplitude, or waveform are often directly used to the acquisition system for conventional microseismic monitoring and conventional seismic data (generally displacement, velocity, or acceleration data, but not strain data). However, the strain data first need to be converted to the conventional seismic data, which has low efficiency and low precision.

The objective of some embodiments of the present disclosure is to provide a method and system for real-time calculating microseismic focal mechanism based on deep learning, which directly uses DAS strain data without converting DAS strain data, thus improving efficiency and accuracy of focal mechanism calculation.

In order to make the above objective, features and advantages of the present disclosure more comprehensible, the present disclosure will be further described in detail below in conjunction with the accompanying drawings and detailed description.

### Embodiment 1

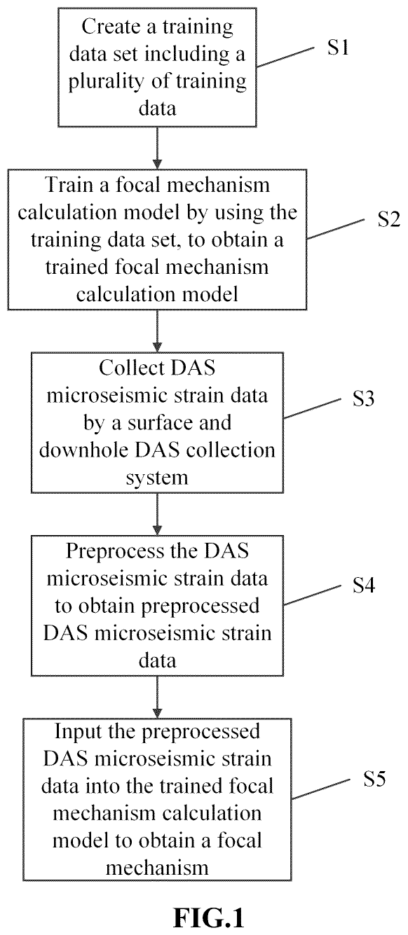

This embodiment provides a method for real-time calculating microseismic focal mechanism based on deep learning. As shown in the flowchart of FIG. 1, the method for calculating microseismic focal mechanism includes the following steps S1-S5.

In S1, a training dataset including several pieces of training data is built. The training data includes simulated DAS microseismic strain data and a focal mechanism corresponding to the simulated DAS microseismic strain data. For single DAS microseismic strain data, there are Nt channels, and each channel includes Ns sampling points; parameters of the focal mechanism include rake angle, strike angle, and dip angle; the strike angle is a direction angle of an intersection line between a fault plane and a horizontal plane, and the dip angle is an angle between the fault plane and the horizontal plane, and the rake angle is an angle between a fault rake vector and the strike.

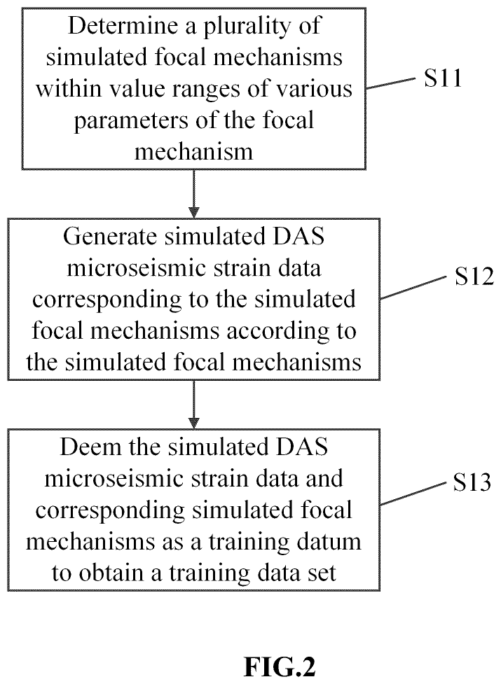

In this embodiment, as shown in FIG. 2, step S1 specifically includes S11-S13.

In S11, within value ranges of various parameters of focal mechanism, several simulated focal mechanisms are determined. The value ranges of various parameters of the focal mechanism are: 0°<rake angle<180°, 0°<strike angle<360°, 0°<dip angle<90°. In some embodiments, the values of the rake angle, strike angle and dip angle may range from 0° to 360°. In this embodiment, the rake angle rake (181° to 360°) and the dip angle dip (91°˜360° are set to zero, so as to facilitate the construction and processing of dataset.

It should be noted that the simulated focal mechanisms determined in step S11 conform to Gaussian distribution centered on an accurate focal mechanism, and the angular resolution is 1°. The calculation formula for the Gaussian distribution is as follows.

$$M ( rake ) = \frac{{( rake - r 0 )}^{2}}{2 {σ}_{2}^{2}}$$

$$M ( strike ) = \frac{{( strike - s 0 )}^{2}}{2 {σ}_{2}^{2}}$$

$$M ( dip ) = \frac{{( dip - d 0 )}^{2}}{2 {σ}_{2}^{2}}$$

Where rake, strike and dip are values of various parameters of the simulated focal mechanisms, respectively, r0 is an accurate rake angle, σ is a standard deviation of the Gaussian distribution, s0 is an accurate strike angle, and d0 is an accurate dip angle.

In S12, according to the simulated focal mechanisms, the simulated DAS microseismic strain data corresponding to the simulated focal mechanisms are generated. In some embodiments, after determining the simulated focal mechanisms, a focal location parameter is determined, the location is generally located near the fracturing stage, and simulates possible focal locations (x, y, z). DAS microseismic strain data is simulated by using analytical Green's function under a velocity model of the region. In this embodiment, horizontal layered velocity is obtained according to logging data, and then an inclined layered velocity model is constructed according to the dip angle of the formation, and DAS microseismic strain data is simulated under the inclined layered velocity model.

The real DAS microseismic strain data usually have the background noise. Therefore, in order to make the simulated DAS microseismic strain data more consistent with the real acquired DAS microseismic strain data, after the simulated DAS microseismic strain data corresponding to the simulated focal mechanisms is generated, the method for calculating microseismic focal mechanism also includes the following step.

Background noise collected by a real acquisition system is added to several simulated DAS microseismic strain data to simulate signal-to-noise ratio and characteristics of the real collected data.

In S13, the simulated DAS microseismic strain data and the corresponding simulated focal mechanism are deemed as a piece of training data, to obtain a training dataset.

Through different experiments, in the process of monitoring real DAS microseismic strain data, some abnormal data are occasionally collected for some reasons, such as channel anomalies; therefore, before training the focal mechanism calculation model with the training dataset, the method for calculating microseismic focal mechanism also includes the following steps.

randomly selecting multiple simulated DAS microseismic strain data in the training dataset;

setting data of random multiple channels in the selected simulated DAS microseismic strain data to null, to obtain simulated DAS microseismic strain data with abnormal channels; and scaling amplitude of background noise in the selected simulated DAS microseismic strain data, so that the dataset participating in the model training is more consistent with the real DAS microseismic strain data distribution.

In S2, the focal mechanism calculation model is trained with the training dataset, so as to obtain the trained focal mechanism calculation model with the simulated DAS microseismic strain data as input, and the focal mechanism corresponding to the simulated DAS microseismic strain data as a target output. The training of the model is completed on a GPU image processing unit.

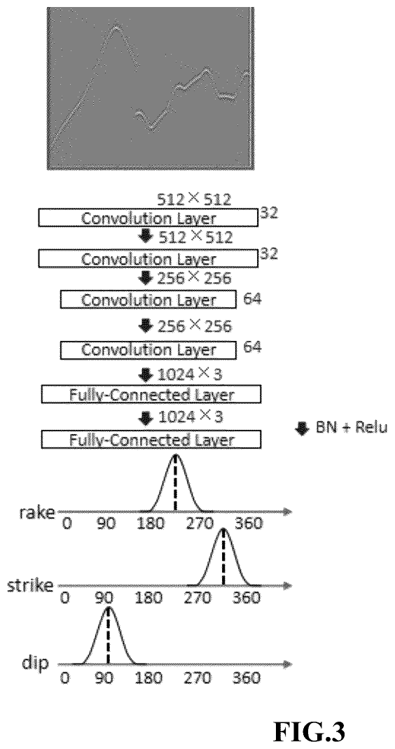

In this embodiment, the focal mechanism calculation model is a neural network model. As shown in FIG. 3, the focal mechanism calculation model includes 4 convolution blocks and 2 fully-connected blocks, which are connected in sequence. The 4 convolution blocks each include a convolution layer, an activation layer, a maximum pooling layer and a Dropout layer connected in sequence. The activation layer uses a ReLU activation function. A 2D convolution layer is adopted, a kernel size of the convolution is set to (64×3 x3), and model training parameters padding and stride are 1 and 2, respectively. A stochastic gradient descent optimization method is adopted. A dynamic learning rate η is set, an initial value of η is set to 0.0001, which is reduced by half every 50 epochs, a batch size is set to 40, and a number of iterations is 200. Hyperparameters of the calculation model are updated by error between the calculated focal mechanism and the focal mechanism corresponding to the simulated DAS microseismic strain data. In this embodiment, mean squared error MSE (mean squared error) is used as a loss function to calculate the error of the focal mechanism calculation model.

In S3, DAS microseismic strain data is collected by a surface and downhole DAS acquisition system; the DAS microseismic strain data includes P-wave information and/or S-wave information with Ns sampling points and Nt channels.

The existing acquisition of conventional microseismic data is generally divided into surface microseismic monitoring, well microseismic monitoring and so on. Geophones for surface monitoring are far away from the reservoir, and are easily interfered by strong noise of engineering. The number of geophones for well monitoring is small and its collection azimuth angle is narrow, and there are many restrictions on deployment of conventional geophones.

DAS is a data acquisition technology that has developed rapidly in recent years. The main advantage of DAS is that an optical fiber is used as an integrated carrier for signal reception and transmission, which gives good real-time performance. The optical fiber has other characteristics, such as no electromagnetic radiation interference, high temperature resistance and inert chemical reaction, which is suitable for complex working environment.

DAS monitoring is generally divided into in-well monitoring and offset-well monitoring. In the in-well monitoring, the monitoring well and the fracturing well are the same horizontal well; in the offset-well monitoring, the monitoring well and the fracturing well are different horizontal wells. However, both the in-well monitoring and offset-well monitoring are downhole observation, and the observation orientation is relatively limited.

At present, in addition to the above two well monitoring methods, DAS microseismic strain data are collected by an downhole optical fiber acquisition system and surface geophones, but the observation orientation is relatively narrow (the orientation is wide along the well direction, but the orientation perpendicular to the well direction is narrow). Moreover, the geophones generally used in the well acquisition system have a small number of channels (the geophone has hundreds of channels, and the optical fiber may reach thousands of channels). Surface geophones and downhole optical fiber jointly collect data, and data types collected by the both systems are inconsistent (one is microseismic strain data, and the other is microseismic velocity or acceleration data), which leads to problems in following processings. Others adopt downhole geophones and surface geophones to collect microseismic data, but the amount of collected data is small and the orientation is narrow.

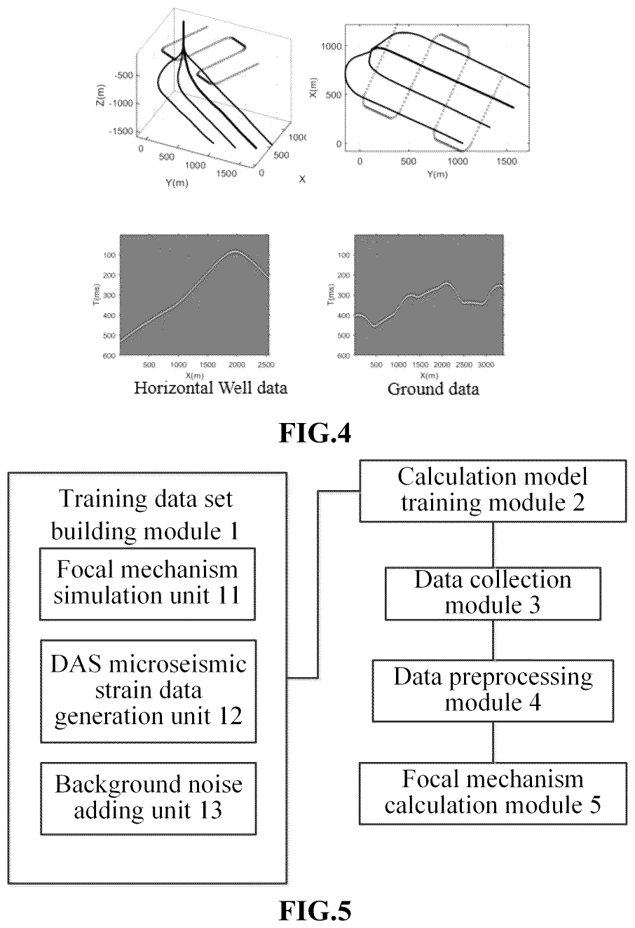

Therefore, in the present disclosure, the surface and downhole distributed optical fiber acoustic wave sensing acquisition system is adopted to collect DAS microseismic strain data. On the basis of the in-well monitoring and the offset-well monitoring, surface optical fibers are further arranged to realize surface collection and obtain omni-directional observation data. The system has a large amount of data, and the observation orientation is wider than that in the prior art. As shown on the left side of FIG. 4, the surface and downhole distributed optical fiber acoustic sensing acquisition system includes surface optical fiber and downhole optical fiber. The surface optical fiber is arranged on the surface in a snake shape, and the downhole optical fiber is arranged along the horizontal well in a rake shape. As shown on the right side of FIG. 4, the surface optical fiber and the downhole optical fiber are orthogonal in top view. Both the surface optical fiber and the downhole optical fiber include metal casings and single-mode optical fibers. An armored optical cable is fixed on an outer side of the metal casing, a special single-mode optical fiber is arranged in the armored optical cable, a DAS modem instrument is placed near the wellhead, and a signal port of the DAS modem instrument is connected with the special optical fiber outside the casing. The erection and use steps of the surface and downhole distributed optical fiber acoustic wave sensing acquisition system include as follows.

A1. The metal casing and the armored optical cable are synchronously and slowly lowered into a drilled well hole.

A2. A ring-shaped metal clamp is installed at a joint of two metal casings at the wellhead to fix and protect the armored optical cable from moving and/or being damaged during lowering casings.

A3. Cement slurry is pumped from a bottom of the well by a high-pressure pump truck, so that the cement slurry returns to the wellhead from the bottom of the well along the annular space between an outer wall of the metal casing and the drilled hole. After the cement slurry is consolidated, the metal casing, the armored optical fiber and formation rock are permanently fixed together.

A4. The single-mode optical fiber outside the casing in the armored optical cable is connected to the DAS signal input port of the DAS modem instrument at the wellhead.

A5. 3D surface seismic data in the area around the horizontal well is collected and preprocessed to obtain 3D seismic P-wave velocity volume, and then the 3-D seismic P-wave velocity is calibrated, adjusted and updated by the acoustic logging velocity data, to obtain the preliminary seismic P-wave velocity model of the formation around the horizontal well.

A6. Directional perforation operations are carried out on the metal casings sequentially at pre-designed perforation positions in the well. Perforation signals generated during directional perforation operation is recorded by using the single-mode optical fiber outside the casing laid in the well and a DAS modem instrument near the wellhead. With travel time difference of P-waves of these perforation signals, the preliminary seismic P-wave velocity model in step A5 is calibrated and updated to obtain a final velocity model for hydraulic fracturing microseismic event analysis.

A7. During hydraulic fracturing operations, this system can use the armored optical cable permanently laid outside the metal casing for hydraulic fracturing microseismic monitoring. Data is collected by the single-mode optical fiber outside the casing laid in the well, and transmitted to the DAS modem instrument near the wellhead for demodulation. Microseismic events are continuously recorded when downhole stimulation of offset-wells or the in-wells are performed.

A8. According to time, three-dimensional spatial location and energy magnitude of the microseismic events monitored in real time during the hydraulic fracturing operations, interval analysis theory is used to analyze reliability of results such as focal location and excitation time, so as to obtain a confidence interval and corresponding reliability value. By analyzing all observed microseismic events, dynamic distribution and change of positions of microseismic events in a three-dimensional space can be obtained. Furthermore, based on this information, various parameters during hydraulic fracturing operations can be optimized and adjusted in real time.

A9. After the hydraulic fracturing is completed, the focal mechanism analysis and magnitude analysis are carried out according to recorded signal characteristics of microseismic events, and rupture mechanism of most microseismic events is obtained. The total reconstructed volume SRV produced during the hydraulic fracturing operations is calculated by using envelope of all microseismic events monitored in real time in three-dimensional spatial distribution range. Based on the above information, reservoir hydraulic fracturing reconstruction effect of this horizontal well is effectively and reliably evaluated qualitatively and quantitatively.

In S4, the DAS microseismic strain data is preprocessed to obtain preprocessed DAS microseismic strain data. The preprocessing includes removing abnormal large values from data recorded in each channel of the DAS microseismic strain data. The preprocessing operations can also include interpolation and replacement of damaged channel data in the DAS microseismic strain data, and removal of mean value of the data collected by each channel.

In S5, the preprocessed DAS microseismic strain data is input into a trained focal mechanism calculation model to obtain a focal mechanism. As shown in FIG. 3, input of the focal mechanism calculation model is DAS microseismic strain data containing P wave information and/or S wave information, and a last fully-connected block outputs vector data corresponding to three parameters of the focal mechanism, and respective maximum values on three vectors correspond to values of the three parameters of the focal mechanism currently calculated.

The method for calculating a microseismic focal mechanism provided in this embodiment uses the training dataset to train the focal mechanism calculation model, so that the focal mechanism calculation model learns relationship between the DAS microseismic strain data and the focal mechanism, so as to accurately obtain the focal mechanism through the DAS microseismic strain data calculation, thus improving efficiency of focal mechanism calculation. Further, the DAS microseismic strain data in the present disclosure uses P-wave information and/or S-wave information. Compared with an existing focal mechanism inversion strategy, it is no longer limited to use single type of the information, and the focal mechanism finally calculated is more accurate. In addition, in the present disclosure, corresponding DAS microseismic strain data is generated through focal mechanism simulation, so that the amount of data that can participate in the training of the focal mechanism calculation model is improved, and the problems like lacking of training data and the inadequate training of focal mechanism calculation model are avoided.

### Embodiment 2

As shown in the diagram in FIG. 5, corresponding to a method for real-time calculating a microseismic focal mechanism based on deep learning provided in Embodiment 1, Embodiment 2 provides a system for real-time calculating a microseismic focal mechanism based on deep learning, the system includes a training dataset creating module 1, a calculation model training module 2, a data collection module 3, a data preprocessing module 4, and a focal mechanism calculation module 5.

The training dataset building module 1 is configured to build a training dataset including several pieces of training data; the training data includes simulated DAS microseismic strain data and a focal mechanism corresponding to the simulated DAS microseismic strain data; parameters of the focal mechanism include a rake angle, a strike angle and a dip angle.

The calculation model training module 2 is configured to train a focal mechanism calculation model by using the training dataset, with the simulated DAS microseismic strain data as an input and the focal mechanism corresponding to the simulated DAS microseismic strain data as a target output, so as to obtain a trained focal mechanism calculation model.

The data collection module 3 is configured to collect DAS microseismic strain data by a surface and downhole DAS acquisition system. The DAS microseismic strain data includes P-wave information and/or S-wave information recorded in multiple channels.

The data preprocessing module 4 is configured to preprocess the DAS microseismic strain data to obtain preprocessed DAS microseismic strain data. The preprocessing includes removing abnormal large values from data recorded in each channel of the DAS microseismic strain data.

The focal mechanism calculation module 5 is configured to input the preprocessed DAS microseismic strain data into the trained focal mechanism calculation model to obtain a focal mechanism.

When neural network training is performed, if the amount of data is too small, the training of the focal mechanism calculation model will be inadequate. Therefore, in order to increase the amount of data that can participate in the training of the focal mechanism calculation model, in this embodiment, the training dataset building block 1 includes a focal mechanism simulation unit 11 and a DAS microseismic strain data generation unit 12.

The focal mechanism simulation unit 11 is configured to determine multiple simulated focal mechanisms within the value ranges of various parameters of the focal mechanism.

The DAS microseismic strain data generation unit 12 is configured to generate simulated DAS microseismic strain data corresponding to each simulated focal mechanism according to the simulated focal mechanism. The simulated DAS microseismic strain data and the corresponding simulated focal mechanisms are used as a training datum to obtain the training dataset.

The real DAS microseismic strain data usually have the background noise. Therefore, in order to make the simulated DAS microseismic strain data more consistent with real obtained DAS microseismic strain data, in this embodiment, the training dataset building module 1 further includes a background noise adding unit 13.

The background noise adding unit 13 is configured to add background noise to multiple simulated DAS microseismic strain data. The background noise is background noise during real monitoring.

Specific examples are applied herein, but the above description only sets forth principles and implementations of the present disclosure, and the description of the above embodiments is only used to help understand the method of the present disclosure and its core idea. It should be understood by those skilled in the art that each module or each step of the present disclosure can be realized by a general-purpose computer device. Alternatively, they can be realized by program codes executable by a computing device. Therefore, they can be stored in a storage device and executed by the computing device, or they can be fabricated into individual integrated circuit modules, or multiple modules or steps in them can be fabricated into a single integrated circuit module. The present disclosure is not limited to any specific combination of hardware and software.

Further, for those of ordinary skill in the art, there will be changes in the specific embodiment and application scope according to the idea of the present disclosure. In summary, contents of this specification should not be understood as limiting the present disclosure.

1. A method for real-time calculating a microseismic focal mechanism based on deep learning, comprising steps:
building a training dataset comprising a plurality of training data, the training data comprising simulated Distributed Acoustic Sensing (DAS) microseismic strain data and a focal mechanism corresponding to the simulated DAS microseismic strain data, and parameters of the focal mechanism comprising a rake angle, a strike angle and a dip angle;
training a focal mechanism calculation model by using the training dataset, with the simulated DAS microseismic strain data as an input and the focal mechanism corresponding to the simulated DAS microseismic strain data as a target output, so as to obtain a trained focal mechanism calculation model, wherein the focal mechanism calculation model is a neural network model, and the focal mechanism calculation model comprises four convolution blocks and two fully-connected blocks which are connected in sequence, the four convolution blocks each comprise a convolution layer, an activation layer, a maximum pooling layer and a Dropout layer connected in sequence, the activation layer adopts a ReLU activation function, and a 2D convolution layer is adopted;
collecting DAS microseismic strain data by a ground and downhole DAS acquisition system, the DAS microseismic strain data comprising P-wave information and/or S-wave information recorded in a plurality of channels;
preprocessing the DAS microseismic strain data to obtain preprocessed DAS microseismic strain data, the preprocessing comprising removing abnormal values from data recorded in each channel of the DAS microseismic strain data;
inputting the preprocessed DAS microseismic strain data into the trained focal mechanism calculation model to obtain a focal mechanism for revealing a generation mechanism of microseism and stress change of underground reservoirs, and
optimizing hydraulic fracturing with the focal mechanism;
wherein after the step of building a training dataset comprising a plurality of training data, the method further comprises:
randomly selecting a plurality of the simulated DAS microseismic strain data in the training dataset;
setting data of a plurality of random channels in the selected simulated DAS microseismic strain data to null, to obtain simulated DAS microseismic strain data with abnormal channels;
wherein the step of building a training dataset comprising a plurality of training data comprises:
determining a plurality of simulated focal mechanisms within value ranges of various parameters of the focal mechanism;
generating simulated DAS microseismic strain data corresponding to each simulated focal mechanism;
deeming each simulated DAS microseismic strain data and corresponding simulated focal mechanism as a training datum to obtain a training dataset,
wherein value ranges of various parameters of the focal mechanism are: 0°<rake angle<180°, 0°<strike angle<360°, 0°<dip angle<90°;
wherein the simulated focal mechanisms conform to Gaussian distribution centered on an accurate focal mechanism, and an angular resolution is 1°, the calculation formula for the Gaussian distribution is as follows:
$$M ( rake ) = \frac{{( rake - r 0 )}^{2}}{2 {σ}_{2}^{2}}$$
$$M ( strike ) = \frac{{( strike - s 0 )}^{2}}{2 {σ}_{2}^{2}}$$
$$M ( dip ) = \frac{{( dip - d 0 )}^{2}}{2 {σ}_{2}^{2}}$$
where rake, strike and dip are values of various parameters of the simulated focal mechanisms, respectively, r0 is an accurate rake angle, σ is a standard deviation of the Gaussian distribution, s0 is an accurate strike angle, and d0 is an accurate dip angle.

2. (canceled)

3. (canceled)

4. The method according to 1, wherein after the step of generating simulated DAS microseismic strain data corresponding to each simulated focal mechanism according to the simulated focal mechanism, and before the step of deeming each simulated DAS microseismic strain data and corresponding simulated focal mechanism as a training datum to obtain a training dataset, the method further comprises:
adding background noise to a plurality of the simulated DAS microseismic strain data, the background noise being background noise during real monitoring.

5. (canceled)

6. A system for real-time calculating a microseismic focal mechanism based on deep learning, comprising:
a processor; and
a memory having program instructions stored,
wherein when the processor executes the program instructions stored on the memory, the processor is configured to:
build a training dataset comprising a plurality of training data, the training data comprising simulated DAS microseismic strain data and a focal mechanism corresponding to the simulated DAS microseismic strain data, and parameters of the focal mechanism comprising a rake angle, a strike angle and a dip angle;
train a focal mechanism calculation model by using the training dataset, with the simulated DAS microseismic strain data as an input, and the focal mechanism corresponding to the simulated DAS microseismic strain data as a target output, so as to obtain a trained focal mechanism calculation model, wherein the focal mechanism calculation model is a neural network model, and the focal mechanism calculation model comprises four convolution blocks and two fully-connected blocks which are connected in sequence, the four convolution blocks each comprise a convolution layer, an activation layer, a maximum pooling layer and a Dropout layer connected in sequence, the activation layer adopts a ReLU activation function, and a 2D convolution layer is adopted;
collect DAS microseismic strain data by a surface and downhole DAS acquisition system, the DAS microseismic strain data comprising P-wave information and/or S-wave information recorded in a plurality of channels;
preprocess the DAS microseismic strain data to obtain preprocessed DAS microseismic strain data, the preprocessing comprising removing abnormal values from data recorded in each channel of the DAS microseismic strain data;
input the preprocessed DAS microseismic strain data into the trained focal mechanism calculation model to obtain a focal mechanism for revealing a generation mechanism of microseism and stress change of underground reservoirs, and
optimize hydraulic fracturing with the focal mechanism,
wherein after the step of building a training dataset comprising a plurality of training data, the processor is further configured to:
randomly select a plurality of the simulated DAS microseismic strain data in the training dataset;
set data of a plurality of random channels in the selected simulated DAS microseismic strain data to null, to obtain simulated DAS microseismic strain data with abnormal channels;
wherein the processor is further configured to:
determine a plurality of simulated focal mechanisms within value range of various parameters of the focal mechanism;
generate simulated DAS microseismic strain data corresponding to each simulated focal mechanism, and to deem each simulated DAS microseismic strain data and corresponding simulated focal mechanism as a training datum to obtain a training dataset,
wherein value ranges of various parameters of the focal mechanism are: 0°<rake angle<180°, 0°<strike angle<360°, 0°<dip angle<90°;
wherein the simulated focal mechanisms conform to Gaussian distribution centered on an accurate focal mechanism, and an angular resolution is 1°, the calculation formula for the Gaussian distribution is as follows:
$$M ( rake ) = \frac{{( rake - r 0 )}^{2}}{2 {σ}_{2}^{2}}$$
$$M ( strike ) = \frac{{( strike - s 0 )}^{2}}{2 {σ}_{2}^{2}}$$
$$M ( dip ) = \frac{{( dip - d 0 )}^{2}}{2 {σ}_{2}^{2}}$$
where rake, strike and dip are values of various parameters of the simulated focal mechanisms, respectively, r0 is an accurate rake angle, σ is a standard deviation of the Gaussian distribution, s0 is an accurate strike angle, and d0 is an accurate dip angle.

7. (canceled)

8. The system according to 6, wherein the processor is further configured to:
add background noise to a plurality of the simulated DAS microseismic strain data, the background noise being background noise during real monitoring.
